(19) United States
(12) Patent Application Publication
(10) Pub. No.: US 2021/0336398 A1
(43) Pub. Date: Oct. 28, 2021

(54) Busbar for a Conductor Line

(71) Applicant: Conductix-Wampfler GmbH, Weil am Rhein (DE)

(72) Inventor: Dieter SEIDEL, Steinen (DE)

(73) Assignee: Conductix-Wampfler GmbH, Weil am Rhein (DE)

(21) Appl. No.: 17/238,305

(22) Filed: Apr. 23, 2021

(30) Foreign Application Priority Data
Apr. 24, 2020 (DE) 10 2020 111 272.6

(51) Int. Cl. H01R 41/00; H01R 25/14

(52) U.S. Cl. CPC H01R 41/00; H01R 25/145

(57) ABSTRACT

A busbar for a conductor line for supplying electrical power to an electrical load which can be moved along the conductor line. To reduce the wear on the busbar and the sliding body that slides along the conductor line by decreasing the friction between these two components, a busbar, on which the surface of the side of the busbar intended to make contact with a sliding body of a current collector has at least one groove-shaped depression, which, at least in certain sections, runs at an oblique angle relative to the longitudinal direction of the busbar, with the longitudinal direction defined by the intended direction of movement of the sliding body.

### FIELD OF THE DISCLOSURE

The disclosure relates to a busbar for a conductor line for supplying electrical power to an electrical load which can be moved along the conductor line.

### BACKGROUND

During operation of a movable electrical load which is supplied with electrical power via a conductor line, busbars of conductor lines as well as sliding bodies of current collectors are subject to wear for reasons inherent to the system. This wear can be reduced by applying a friction-reducing material to the busbar surface, which, during operation of a conductor line, makes contact with the sliding body. However, the problem arising in this context is the proportion of coverage between the sliding body and the busbar, which, compared with a slip ring body, is extremely low, since when a lubricant-containing sliding body is used, the amount of lubricant that can be applied per unit length of the busbar is relatively small due to the abrasion from the sliding body.

For operation of a conductor line, one possibility of applying a larger amount of lubricant is the use of a sliding body made of a friction-reducing material, such as graphite. However, when a conductor line with a conventional sliding body made of copper graphite, for example, is operated, a large portion of the lubricant additionally applied in this manner is pushed by the sliding body toward the ends of the conductor line, thereby rendering it ineffective.

### SUMMARY

One aspect of the disclosure relates to reducing the wear on the busbar and the sliding body by decreasing the friction between these two components on a conductor line.

Accordingly, a busbar is disclosed herein. Advantageous refinements and embodiments are also disclosed.

In an embodiment, on a busbar for a conductor line for supplying electrical power to an electrical load which moves along the conductor line, the surface of the side of the busbar intended to make contact with a sliding body of a current collector has at least one groove-shaped depression which, at least in certain sections, runs at an oblique angle relative to the longitudinal direction of the busbar, where this direction is defined by the intended direction of movement of the sliding body. In this context, ‘at least in certain sections runs at an oblique angle relative to’ is defined to mean that the depression runs at an oblique angle along a portion of its length. Such a depression forms a reservoir for a lubricant, which can be powderized, for example, and hinders the discharge of such a lubricant to the ends of the busbar as a result of the sliding of the sliding body over the contact surface of the busbar it opposes. By retaining lubricant on the busbar in the depression, the wear caused by friction on the busbar and on the sliding body is reduced.

In a preferred embodiment of a depression, the depression extends continuously along each contiguous section of a busbar. This type of shape of the depression is particularly well-suited for production in a continuous process which includes the profiling of the busbar. The depression preferably runs at regular intervals along the longitudinal direction of the busbar, which causes the depression to have a uniform effect along the longitudinal direction of the busbar.

A useful shape of the depression as seen in plan view is a sinuous line with a plurality of uniform rounded loops which, starting from of a longitudinal center axis of the busbar, alternately extend in opposite directions. For example, when seen in plan view, the depression can be at least approximately sinusoidal in form or consist of a continuous sequence of interconnected circular arcs of the same radii. This results in an overall symmetrical shape of the depression relative to the longitudinal center axis.

Another useful shape of the depression as seen in plan view is the shape of a zigzag line with a plurality of straight sections which cross the longitudinal center axis of the bus bar, alternately switching in opposite directions. All of the straight sections of the zigzag line preferably have the same length and cross the longitudinal center axis of the busbar at the same angular measure. This results in a symmetrical shape of the zigzag line relative to the longitudinal center axis.

As an alternative to a single continuous depression, each contiguous section of the busbar can also have a plurality of separate depressions. The inventive effect can also be obtained if at least certain sections of the depressions run at an oblique angle relative to the longitudinal direction of the busbar. In this case, the depressions preferably have the same shape and are arranged in the longitudinal direction of the busbar so as to be separated by same distance. Such separate depressions can be especially simply and conveniently implemented in that, when seen in plan view, they run in a straight line and parallel to each other at an oblique angle relative to the longitudinal center axis of the busbar.

The depression or depressions can have a cross section that is V-shaped or has a rounded bottom and is or are preferably integrated into the busbar during the process of its formation, which avoids additional costs that would arise as a result of subsequent production. Such a formation process is necessary especially if the busbar has a curved cross-sectional shape and the side intended for contact with a sliding body of a current collector is the concave side. This cross-sectional shape is especially convenient since it ensures the self-centering of the sliding body of the current collector along the lateral direction and counteracts the escape of lubricant from the busbar along the lateral direction.

### BRIEF DESCRIPTION OF THE DRAWINGS

The busbar will be described below based on detailed embodiment examples with reference to the accompanying drawings. The drawings show:

FIG. 1 a three-dimensional oblique view of a first embodiment of a busbar according to the disclosure,

FIG. 2 a plan view of the contact surface of the busbar shown in FIG. 1,

FIG. 3 a longitudinal section through FIG. 2 along line A-A,

FIG. 4 a three-dimensional oblique view of a second embodiment of a busbar according to the disclosure,

FIG. 5 a plan view of the contact surface of the busbar shown in FIG. 4,

FIG. 6 a longitudinal section through FIG. 2 along line B-B,

FIG. 7 a three-dimensional oblique view of a third embodiment of a busbar according to the disclosure,

FIG. 8 a plan view of the contact surface of the busbar shown in FIG. 7,

FIG. 9 a longitudinal section through FIG. 2 along line C-C.

### DETAILED DESCRIPTION

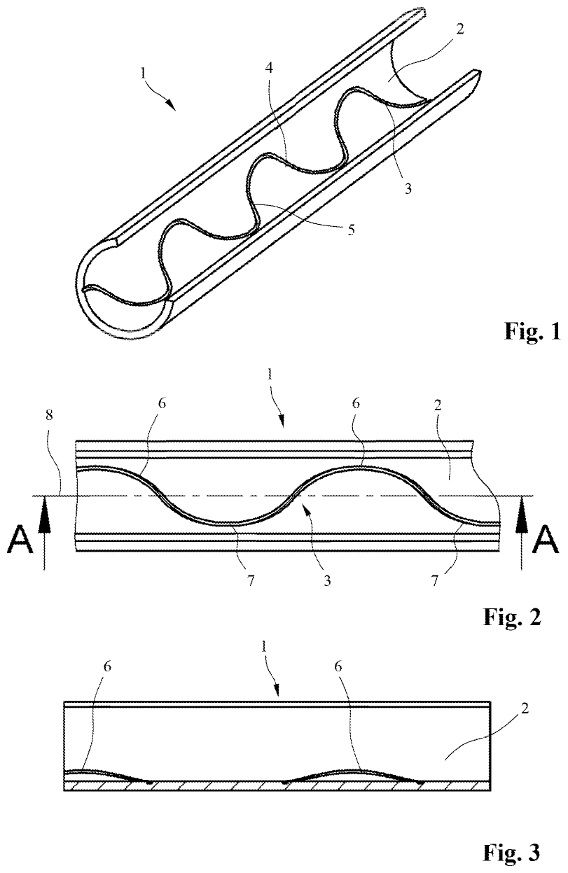

FIG. 1 shows a three-dimensional oblique view of a first embodiment of a busbar 1 according to the disclosure for a conductor line for supplying electrical power to a movable electrical load. The busbar 1 consists of a metal strip having a curved cross-sectional shape, which metal strip can be produced especially by roll forming. In the example shown, the cross section has the shape of a segment of a hollow cylinder, which segment extends over an angle of more than 180°. The surface 2 of the concave side of the busbar 1 is the contact surface of the busbar 1, which means that during operation, the surface is contacted by a sliding body (not shown in the figures) of a current collector of the electrical load.

To reduce the friction caused by the sliding of the sliding body on the surface 2 of the busbar 1, this surface 2 has a groove-shaped depression 3 which is intended to receive a portion of a lubricant that is applied to the surface 2 and to reduce the advance of the lubricant caused by the sliding of the sliding body on the surface 2 along the longitudinal direction of the busbar 1, which longitudinal direction is the direction of movement of the sliding body. To this end, at least portions of the groove-shaped depression 3 run at an oblique angle relative to the longitudinal direction of the busbar 1. This has the effect that lubricant-containing powder, which is discharged from an oblique section 4 of the depression 3 as the sliding body moves across this section, is at least partially redeposited in the oblique section 5 of the depression 3 next following along the direction of movement of the sliding body, which, during operation of the conductor line, slows down the transport of lubricant from the busbar 1 to the ends of the busbar.

To this end, it is of crucial importance for the depression 3 to have sections which run at an oblique angle relative to the longitudinal direction of the busbar 1, such as the sections 4 and 5 shown in FIG. 1. A groove-shaped depression running parallel relative to the longitudinal direction mentioned would not have the effect intended by the disclosure of providing a reservoir of lubricant which slows down the transport of lubricant by the sliding body in the longitudinal direction. On the other hand, however, the depression 3 should also not extend at right angles relative to the direction of movement of the sliding body, since in such a case, it would be nearly impossible for the sliding body to slide lubricant within the depression in its direction of movement, which could potentially lead to an unevenness of the surface 2 as a result of the upward splashing of lubricant along the depressions extending at right angles relative to the direction of movement of the sliding body.

FIG. 2 shows a plan view of the contact surface of the busbar 1, which contact surface is formed by the surface 2. As already indicated by FIG. 1, this figure also shows that this embodiment of the disclosure has a continuous groove-shaped depression 3 which extends over a section of the busbar 1 along the longitudinal direction of said busbar and which consists of sections, the shape of which is repeated at regular intervals along the longitudinal direction of the busbar 1. The depression 3 generally has the form of a sinuous line with a plurality of uniform rounded loops 6 and 7 which, starting from the longitudinal center axis 8 of the busbar 1, alternately run in opposite directions. In the viewing direction of FIG. 2, this sinuous line can be, for example, approximately sinusoidal in form, or the individual loops 6 and 7 can have the shape of circular arcs of the same radii which continuously merge into each other. As indicated in FIG. 2, the depression 3 preferably extends symmetrically relative to the longitudinal center axis 8 of the busbar 1.

FIG. 3 shows a longitudinal section view along line A-A seen in FIG. 2, which line constitutes the longitudinal center axis 8 of the busbar 1 and the center line of the surface 2. As already seen in FIG. 1 and again shown in FIG. 3, due to the concave curvature of the busbar 1, the loops 6 of the depression 3 extend not only sideways from the longitudinal center axis 8 of the busbar but also slightly upward in that they follow the concave curvature. The same also applies to the other loops 7, which in the viewing direction of FIG. 3 are not visible. Thus, the depression 3 does not extend in a plane but three-dimensionally along its own longitudinal direction.

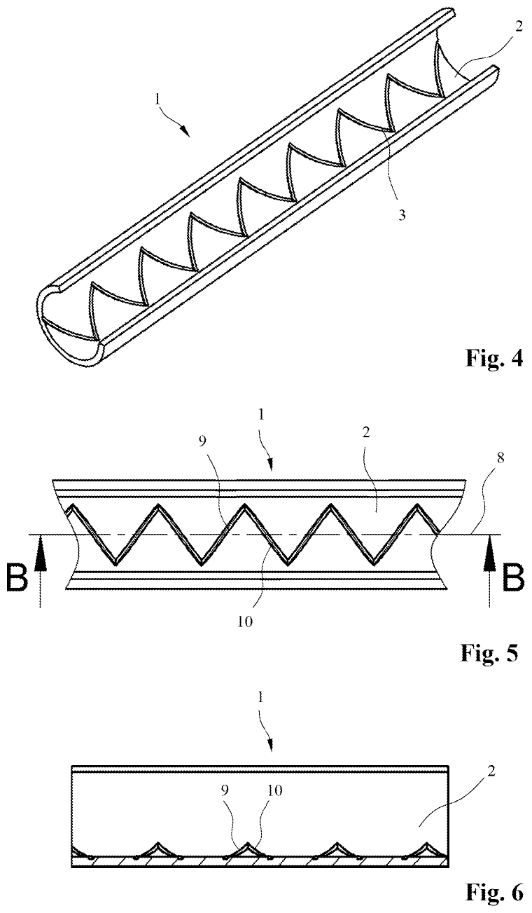

FIGS. 4 to 6 show a second embodiment of a busbar 1 according to the disclosure in the same views in which FIGS. 1 to 3 show the first embodiment. The second embodiment differs from the first embodiment only in the shape of the depression 3, which is the reason that here only this difference will be discussed. In the second embodiment, the depression has the form of a zigzag line. This line consists of a plurality of straight sections 9 and 10 which cross the longitudinal center axis 8 of the busbar 1, switching alternately in opposite directions, and which contiguously merge into each other at their ends.

As shown in FIG. 5, the depression 3 in zigzag-shaped implementation preferably also extends symmetrically relative to the longitudinal center axis 8 of the busbar 1. Again, the shape of the depression 3 is three-dimensional, i.e., it follows the concave curvature of the busbar 1, as indicated in FIG. 6. It is of crucial importance that the individual sections of the depression 3 again run at an oblique angle relative to the longitudinal direction of the busbar 1, which longitudinal direction is the direction of movement of the sliding body of the current collector. In this case, even the angle formed by the longitudinal center axis 8 of the busbar 1 and the depression 3 has the same measure everywhere while in the first embodiment, the measure of this angle along the depression 3 continuously varies between zero and a maximum value.

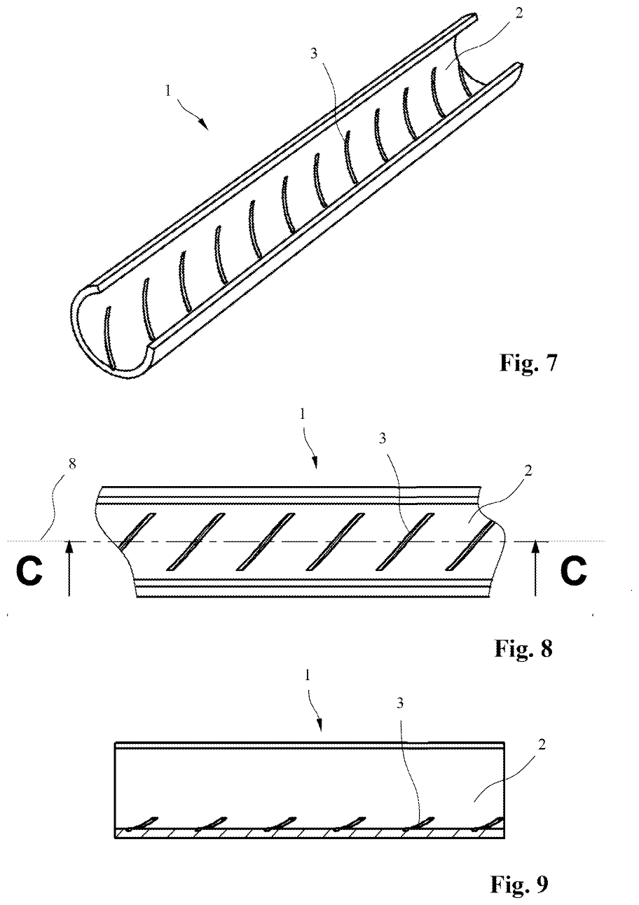

FIGS. 7 to 9 show a third embodiment of a busbar 1 according to the disclosure in the same views in which FIGS. 1 to 3 show the first embodiment and FIGS. 4 to 6 show the second embodiment. The third embodiment differs from the first and second embodiment in that instead of a single continuous depression 3 within one section of the busbar 1, the section has a plurality of separate depressions 3 which, in the longitudinal direction of each contiguous section of the busbar 1, follow each other at the same distance from each other. As FIG. 8 shows, when seen in plan view, the individual depressions 3 have the form of straight lines; they all cross the longitudinal center axis 8 of the busbar 1 at the same angle and extend for the same distance from both sides of the longitudinal center axis 8. Again, the form of the depressions 3 is three-dimensional, i.e., it follows the concave curvature of the busbar 1, as illustrated in FIG. 9. Although the straight-line shape of the depressions 3 of the third embodiment is especially simple and therefore convenient, it is not the only possible shape. Thus, for example, separate depressions 3 could also be configured so as to be sickle-shaped or S-shaped.

### LIST OF REFERENCE CHARACTERS

1 Busbar
2 Surface
3 Depression
4, 5 Oblique section
6, 7 Loop
8 Longitudinal center axis
9, 10 Straight section

1. A busbar for a conductor line for supplying electrical power to an electrical load which is movable along the conductor line, wherein a surface of a side of the busbar intended to make contact with a sliding body of a current collector has at least one groove-shaped depression which, at least in certain sections, runs at an oblique angle relative to a longitudinal direction of the busbar, the longitudinal direction being defined by an intended direction of movement of the sliding body.

2. The busbar of claim 1, wherein the at least one groove-shaped depression includes a single depression extending continuously along a continuous section of the busbar.

3. The busbar of claim 2, wherein the single depression runs at regular intervals along the longitudinal direction of the busbar.

4. The busbar of claim 3, wherein when seen in plan view, the single depression has the form of a sinuous line with a plurality of uniform round loops which, starting from a longitudinal center axis of the busbar, alternately extend in opposite directions.

5. The busbar of claim 4, wherein when seen in plan view, the single depression has an at least approximately sinusoidal form or comprises a continuous sequence of interconnected circular arcs of the same radius.

6. The busbar of claim 3, wherein when seen in plan view, the single depression has the form of a zigzag line with a plurality of straight sections which cross the longitudinal center axis of the busbar alternately in opposite directions.

7. The busbar of claim 6, wherein all straight sections of the zigzag line have the same length and cross the longitudinal center axis of the busbar at the same angular measure.

8. The busbar of claim 1, wherein the at least one groove-shaped depression includes a plurality of separate depressions positioned on a continuous section of the busbar.

9. The busbar of claim 8, wherein the separate depressions have the same shape and, in the longitudinal direction of the busbar, are arranged at the same distance from each other.

10. The busbar of claim 8, wherein when seen in plan view, the separate depressions extend in a straight line and parallel to each other at an oblique angle relative to a longitudinal center axis of the busbar.

11. The busbar of claim 1, wherein each of the at least one groove-shaped depression has a cross section that is V-shaped or is rounded at a bottom portion.

12. The busbar of claim 1, wherein each of the at least one groove-shaped depression is integrated into the busbar as part of a forming process of the busbar.

13. The busbar of claim 1, wherein the busbar has a curved cross-sectional shape and in wherein the side intended to make contact with the sliding body of the current collector is a concave side.
